(19) United States
(12) Patent Application Publication
(10) Pub. No.: US 2019/0130650 A1
(43) Pub. Date: May 2, 2019

(54) SMART HEAD-MOUNTED DEVICE, INTERACTIVE EXERCISE METHOD AND SYSTEM

(71) Applicant: Huizhou TCL Mobile Communication Co., Ltd, Huizhou (CN)

(72) Inventor: Zhe Liu, Huizhou (CN)

(21) Appl. No.: 16/231,941

(22) Filed: Dec. 24, 2018

Related U.S. Application Data
(63) Continuation of application No. PCT/CN2017/082149, filed on Apr. 27, 2017.

(30) Foreign Application Priority Data
Sep. 26, 2016 (CN) 201610854160.1

(51) Int. Cl. G06T 19/00; G06T 13/40; G06K 9/00; G06F 3/01; A63B 24/00; G09B 5/06; A63B 71/06; G09B 19/00

(52) U.S. Cl. CPC G06T 19/006; G06T 13/40; G06K 9/00342; G06F 3/011; A63B 24/0075; A63B 24/0006; A63B 2071/0638; G09B 5/065; A63B 71/0622; G09B 19/003; A63B 2024/0012; A63B 2220/806; A63B 24/0062

(57) ABSTRACT

The disclosure discloses an interactive exercise method, a smart head-mounted device and an interactive exercise method. The interactive exercise method may includes: receiving body movement data and body image data; analyzing the body movement data, and establishing a real-time exercise model; integrating the real-time exercise model and a virtual character image to generate a three-dimensional exercise virtual character; integrating the three-dimensional exercise virtual character and the body image data to generate mixed reality exercise image data; constructing a virtual exercise environment, the virtual exercise environment at least comprising a virtual background environment; integrating the mixed reality exercise image data and the virtual exercise environment to generate a virtual exercise scene; and outputting the virtual exercise scene. By means of the described method, the present disclosure can improve the exactness of a real character, construct a pleasant virtual exercise environment, and provide a sense of true immersion.

### CROSS REFERENCE TO RELATED APPLICATIONS

The present application is a continuation-application of International (PCT) Patent Application No. PCT/CN2017/082149 filed on Apr. 27, 2017, which claims foreign priority of Chinese Patent Application No. 201610854160.1, filed on Sep. 26, 2016 in the National Intellectual Property Administration of China, the entire contents of which are hereby incorporated by reference.

### TECHNICAL FIELD

The present disclosure relates to fields of electronics, and in particular, to an interactive exercise method, an interactive exercise system and a smart head-mounted device.

### BACKGROUND

With the improvement of living standards, more people are paying attention to their physical health. People may take various types of fitness exercises such as dancing, mountain climbing and the like, but most people do not have strong enough perseverance, thus requiring a more interesting exercise way which can attract people to start and keep exercising.

The emergence of virtual reality (VR) technology provides users with an interesting way of exercising, while the current VR fitness products are too simple, as well as involves few interactions and low exactness, and thus cannot provide users with more fun and a true immersion sense. Meanwhile, the user may not know in real time whether his or her movements are normative and standard, whether the physical state is normal during exercising, and whether the exercise intensity is sufficient.

### SUMMARY

One of the technical problems to be solved by the present disclosure is to provide an interactive exercise method and a smart head-mounted device, which can solve the problem of low exactness in the current VR fitness products.

In order to solve the above technical problem, in a first aspect, a technical solution adopted by the present disclosure is to provide an interactive exercise method, including: receiving body movement data and body image data; analyzing the body movement data, and establishing a real-time exercise model; integrating the real-time exercise model and a virtual character image to generate a three-dimensional exercise virtual character; integrating the three-dimensional exercise virtual character and the body image data to generate mixed reality exercise image data; constructing a virtual exercise environment, wherein the virtual exercise environment comprises at least a virtual background environment; integrating the mixed reality exercise image data and the virtual exercise environment to generate a virtual exercise scene; and outputting the virtual exercise scene.

In order to solve the above technical problem, in a second aspect, another technical solution adopted by the present disclosure is to provide a smart head-mounted device, including: a processor and a communication circuit connected to each other, wherein the communication circuit is configured to receive body movement data and body image data; the processor is configured to analyze the body movement data and establish a real-time exercise model, integrate the real-time exercise model and the virtual character image to generate a three-dimensional exercise virtual character, and then integrate the three-dimensional exercise virtual character and the body image data to generate mixed reality exercise image data, construct a virtual exercise environment, integrate the mixed reality exercise image data and the virtual exercise environment to generate a virtual exercise scene, and output the virtual exercise scene, the virtual exercise environment at least including a virtual background environment.

In order to solve the above technical problem, in a third aspect, another technical solution adopted by the present disclosure is to provide an interactive exercise system, including a plurality of inertial sensors configured to be placed in main parts of user's body, a plurality of optical devices configured to be placed in a space where the user is located, corporate with the inertial sensors to obtain body movement data, a plurality of cameras configured to be placed in the space and obtain body image data, and a smart head-mounted device as described in the second part above.

The present disclosure may have the advantages that, different from the prior art, the present disclosure generates a real-time exercise model through the body movement data received in real time, integrates the real-time exercise model with the virtual character image to form a three-dimensional exercise virtual character, then integrates the received body image data and the three-dimensional exercise virtual character to generate mixed reality exercise image data, and finally integrates the mixed reality exercise image data and the constructed virtual exercise environment to generate and output a virtual exercise scene. By the described means, the present disclosure integrates the virtual exercise character and the body image data to generate mixed reality exercise image data, so that the exercise image of the real character gets reflected to the virtual exercise character in real time, the exactness of the real character is improved, and the virtual exercise environment is constructed, further creating a pleasant exercise environment and providing a more true immersion sense.

### BRIEF DESCRIPTION OF THE DRAWINGS

FIG. 1 is a flow chart of a first embodiment of an interactive exercise method according to the present disclosure.

FIG. 2 is a flowchart of a second embodiment of an interactive exercise method according to the present disclosure.

FIG. 3 is a flowchart of a third embodiment of an interactive exercise method according to the present disclosure.

FIG. 4 is a schematic structural diagram of a first embodiment of a smart head-mounted device according to the present disclosure.

FIG. 5 is a schematic structural diagram of a second embodiment of a smart head-mounted device according to the present disclosure.

FIG. 6 is a schematic structural diagram of a third embodiment of a smart head-mounted device according to the present disclosure.

FIG. 7 is a schematic structural diagram of a fourth embodiment of a smart head-mounted device according to the present disclosure.

### DETAILED DESCRIPTION

The technical solutions in the embodiments of the present disclosure are clearly and completely described as follows with reference to the accompanying drawings in the embodiments of the present disclosure. Obviously, the described embodiments are merely a part of the embodiments of the present disclosure, not all of the embodiments. All other embodiments obtained by one with ordinary skills in the art based on the embodiments of the present disclosure without any creative efforts shall fall into the protection scope of the present disclosure.

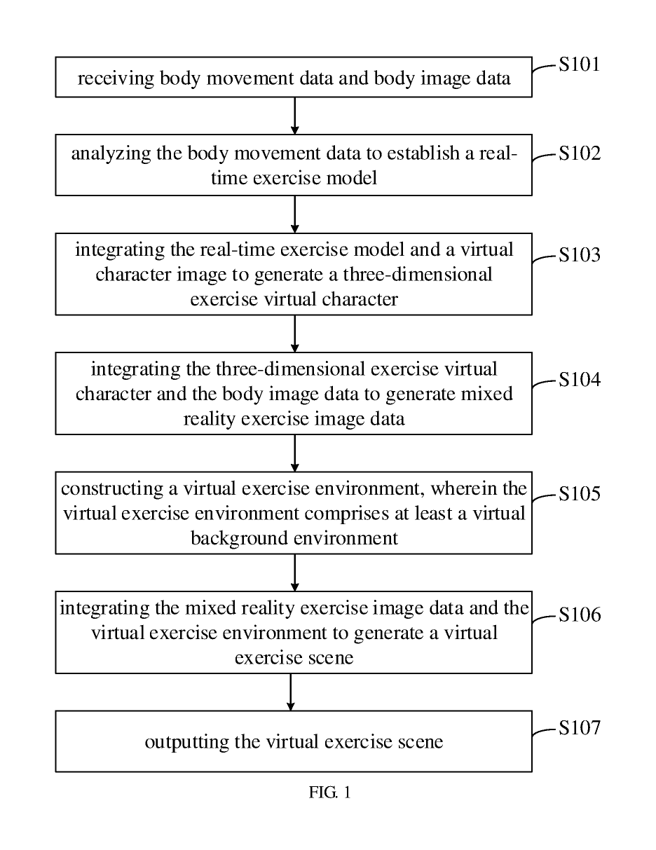

Referring to FIG. 1, FIG. 1 is a flow chart of a first embodiment of an interactive exercise method according to the present disclosure. As shown in FIG. 1, the interactive exercise method of the present disclosure may include following actions at blocks as shown in FIG. 1.

In block S101, the method may include receiving body movement data and body image data.

Herein, the body movement data may come from inertial sensors placed in main parts (such as the head, the hand, the foot, etc.) of the user's body and a plurality of optical devices (such as infrared cameras) placed in a space where the user is located. The body image data may come from a plurality of cameras placed in the space where the user is located.

Specifically, the inertial sensors (such as a gyroscope, an accelerometer, a magnetometer, or an integrated device of the above devices) may obtain body dynamic data (such as acceleration, angular velocity, etc.) according to the movement of the main parts of the user's body (i.e., the data collecting end), and upload the body dynamic data for movement analysis. The main parts of the user body may be also provided with optical reflective devices (such as infrared reflection points), to reflect the infrared lights emitted by the infrared cameras, so that the brightness of the data collecting end is higher than the brightness of the surrounding environment, and at this time, the infrared cameras simultaneously can photograph from different angles, to acquire body movement images, and upload the body movement images for movement analysis. In addition, multiple cameras in the space where the user is located, can simultaneously photograph from different angles to obtain body image data, that is, a body morphological image of the user in a real space, and upload it for integration with the virtual character.

In block S102, the method may include analyzing body movement data and establishing a real-time exercise model.

Herein, the body movement data may include body dynamic data and body movement images.

Specifically, the body dynamic data may be processed according to inertial navigation principles, the exercise angle and velocity of each data collecting end can be obtained, and the body movement image can be processed by an optical positioning algorithm based on computer vision principles, so as to obtain spatial position coordinates and trajectory information of each data collecting end. By combining the spatial position coordinates, trajectory information and exercise angle and velocity of each data collecting end at the same time, it is possible to estimate the spatial position coordinates, trajectory information, exercise angle and velocity at the next moment, thus establishing a real-time exercise model.

In block S103, the method may include integrating a real-time exercise model and a virtual character image to generate a three-dimensional exercise virtual character.

Specifically, the virtual character image may be a preset three-dimensional virtual character, by integrating the virtual character image with the real-time exercise model, and correcting and processing the real-time exercise model according to the body movement data received in real time, the generated three-dimensional exercise virtual character can thereby reflect the user's movement of real space in real time.

Herein, before S103, the method may further include following actions as illustrated in S1031 to S1032.

In block S1031, the method may include detecting whether there is a virtual character image setup command inputted.

Herein, the virtual character image setup command may include gender, height, weight, nationality, skin color, and the like, and the setup command may get selected and inputted by means of voices, gestures, or buttons.

In block S1032, the method may include that if a virtual character image setup command inputted is detected, a virtual character image will be generated according to the virtual character image setup command.

For example, if the virtual character image setup command inputted by the user through a voice selection is female, height 165 cm, weight 50 kg, and China, then a three-dimensional virtual character image conforming to the above setup command can be generated, that is, a simple three-dimensional virtual character image of a Chinese female with a height of 165 cm and a body weight of 50 kg.

In block S104, the method may include integrating the three-dimensional exercise virtual character and the body image data to generate mixed reality exercise image data.

Herein, the body image data may be a morphological image of a user in a real space obtained by simultaneously photographing of a plurality of cameras from different angles.

Specifically, in one application example, the environment background is set in green or blue in advance, and the green screen or blue screen technology can be used to set the environment color to be transparent in the body image data at different angles at the same time, so as to select the user image, and then the selected user image in different angles are processed to form a three-dimensional user image, and finally the three-dimensional user image can be integrated with the three-dimensional exercise virtual character, that is, the three-dimensional exercise virtual character can be adjusted. For example, by adjusting the three-dimensional exercise virtual character according to various parameters or parameter ratio of the three-dimensional user image, such as the height, weight, waistline and arm length, the three-dimensional exercise virtual character therefore can get merged with the real-time three-dimensional user image to generate mixed reality exercise image data. It is certain that, in other application examples, other methods may be used to integrate the three-dimensional exercise virtual character and the body image data, which will not be specifically limited herein.

In block S105, the method may include constructing a virtual exercise environment, the virtual exercise environment including at least a virtual background environment.

Herein, S105 may specifically include following actions.

In block S1051, the method may include detecting whether there is at least one of a virtual background environment setup command and a virtual exercise mode setup command inputted.

Specifically, at least one of the virtual background environment setup command and the virtual exercise mode setup command inputted can be selected and inputted by means of voices, gestures, or buttons. For example, the user can select a virtual exercise background such as an iceberg or grassland by gestures, or select a dancing mode by gestures, and select a dancing track, etc.

Herein, the virtual background environment may be various backgrounds such as a forest, grassland, a glacier, or a stage. The virtual exercise mode may be various modes such as dancing, running, or playing basketball, and is not specifically limited herein.

In block S1052, the method may include that if at least one of the virtual background environment setup command and the virtual exercise mode setup command inputted is detected, the virtual exercise environment may be constructed according to at least one of the virtual background environment setup command and the virtual exercise mode setup command.

Specifically, when the virtual exercise environment is constructed according to at least one of the virtual background environment setup command and the virtual exercise mode setup command, the virtual background environment or the virtual exercise mode data (such as dance audio, etc.) selected by the user may be downloaded through a local database or a network, the virtual exercise background may be switched to the virtual exercise background selected by the user, and related audio may be played, so as to generate a virtual exercise environment. If the user does not select at least one of the virtual background environment and the virtual exercise mode, at least one of a default virtual background environment and a default virtual exercise mode (such as stage and/or dancing) may be used to generate a virtual exercise environment.

In block S106, the method may include integrating the mixed reality exercise image data and the virtual exercise environment to generate a virtual exercise scene.

Specifically, by performing edge processing on the mixed reality exercise image data, that is, the three-dimensional exercise virtual character merged with the three-dimensional user image, the mixed reality exercise image data can be merged with the virtual exercise environment.

In block S107, the method may include outputting the virtual exercise scene.

Specifically, the video data of the virtual exercise scene can be displayed through a display screen, the audio data of the virtual exercise scene can be played through a speaker or a headphone, and the tactile data of the virtual exercise scene can be fed back through a tactile sensor.

In the above embodiment, the virtual exercise character and the body image data may be integrated to generate mixed reality exercise image data, so that the exercise image of the real character can be reflected to the virtual exercise character in real time, and the exactness of the real character is improved, by constructing the virtual reality exercise environment, a pleasant exercise environment can be created and a more true immersion sense may be provided.

In other embodiments, the virtual exercise scene can also be shared with friends to increase interaction and improve exercise fun.

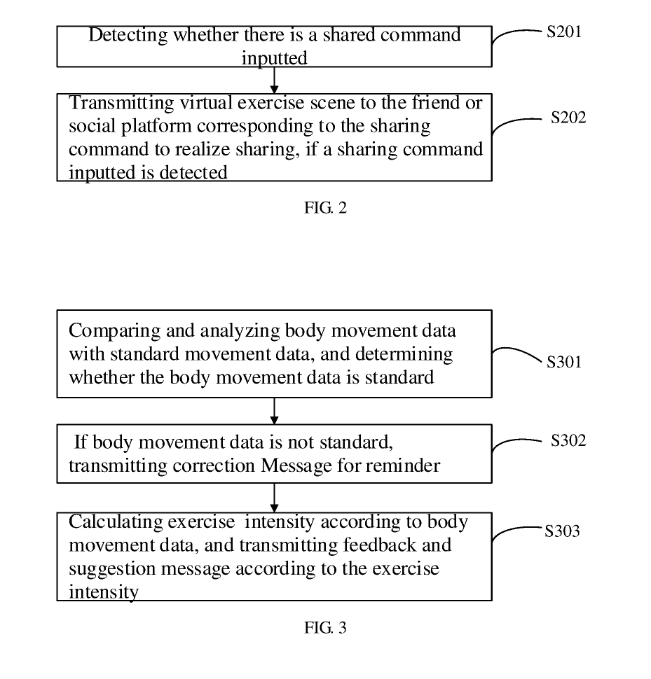

Referring specifically to FIG. 2, FIG. 2 is a flow chart of a second embodiment of the interactive exercise method of the present disclosure. The second embodiment of the interactive exercise method of the present disclosure is based on the first embodiment of the interactive exercise method of the present disclosure, and may further include following actions.

In block S201, the method may include detecting whether there is a sharing command inputted.

Herein, the sharing command may include a shared content and a shared object, and the shared content may include a current virtual exercise scene and a saved historical virtual exercise scene, and the shared object may include a friend and each social platform.

Specifically, the user may input a sharing command by voices, gestures, or buttons to share the current or saved virtual exercise scene (i.e., exercise video or image).

In block S202, the method may include that if a sharing command inputted is detected, a virtual exercise scene may be transmitted to the friend or social platform corresponding to the sharing command to realize sharing.

The social platform may be one or more of various social platforms such as Whatsapp, Twitter, Facebook, WeChat, QQ, and Weibo, and the friend corresponding to the sharing command may be one or more of the pre-saved friends list, which is not specifically limited herein.

Specifically, when the sharing command inputted is detected, if the shared object of the sharing command is a social platform, the shared content may be transmitted to the corresponding social platform. If the shared object of the sharing command is a friend, a pre-saved friends list can be browsed, and when the shared object is found, the corresponding shared content can be transmitted to the shared object, while if the shared object is not found in the saved friends list, the virtual exercise scene will not be transmitted to the shared object and a prompt message is outputted.

For example, the user inputs the following sharing command “share to friend A and friend B” by voice, and the pre-saved friends list will be searched for friend A and friend B, if friend A is found, while friend B is not, the current virtual exercise scene will be transmitted to friend A, and the prompt message of “friend B is not found” will be outputted.

The above actions may be executed after S107. The present embodiment can be combined with the first embodiment of the interactive exercise method of the present disclosure.

In other embodiments, during the exercise process, a virtual coach can also provide guidance or prompt message to increase human-computer interaction and enhance the scientificness and interests.

Referring to FIG. 3 in detail, FIG. 3 is a flowchart of a third embodiment of the interactive exercise method of the present disclosure. The third embodiment of the interactive exercise method of the present disclosure is based on the first embodiment of the interactive exercise method of the present disclosure, and may further include following actions.

In S301, the method includes comparing and analyzing the body movement data with standard movement data to judge whether the body movement data is standard.

Herein, the standard movement data can be data pre-saved in the database or the expert system or downloaded through the network, including the trajectory, angle, strength of the movement, and the like.

Specifically, when comparing and analyzing the received body movement data and the standard movement data, a corresponding threshold may be configured, and when the difference between the body movement data and the standard movement data exceeds the preset threshold, it can be judged that the body movement data is not standard, otherwise the body movement data is judged to be standard. It is certain that, during comparing and analyzing process, other methods, for example the matching ratio between the body movement data and the standard movement data, can be used to judge whether the body movement data is standard, which will not be specifically limited herein.

In block S302, if the body movement data is not standard, a correction message may be transmitted for a reminder.

Specifically, when the body movement data is not standard, a correction message may be transmitted for a reminder by a combination of one or more means of voices, videos, images or texts.

In block S303, the method may include calculating the exercise intensity according to the body movement data, and transmitting a feedback and suggestion message according to the exercise intensity.

Specifically, the exercise intensity may be calculated according to the received body movement data in combination with an exercise duration, and the feedback and suggestion message may be a message suggesting to increase the exercise time or to reduce the exercise intensity during the exercise, or may be a message of such as refueling with hydration or food recommendations prompted after the exercise ends, so that users can understand their own exercise state and can exercise more scientifically and healthily.

In the present embodiment, the exercise intensity may be calculated based on the body movement data, and in other embodiments, the exercise intensity may be obtained from data analysis transmitted by a movement sign related sensor provided on the user.

The above actions can be executed after S107. The present embodiment can be combined with the first embodiment of the interactive exercise method of the present disclosure.

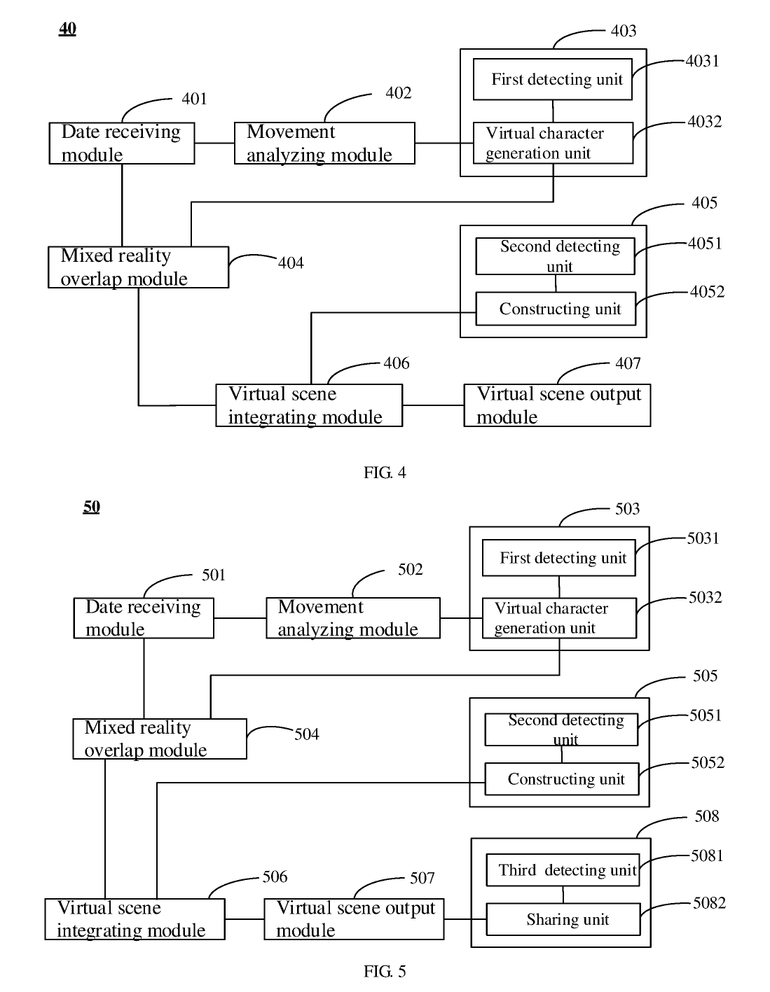

Referring to FIG. 4, FIG. 4 is a schematic structural diagram of a first embodiment of a smart head-mounted device according to the present disclosure. As shown in FIG. 4, the smart head-mounted device 40 of the present disclosure includes: a data receiving module 401, a movement analyzing module 402, a virtual character generation module 403, and a mixed reality overlap module 404, which are sequentially connected, as well as a virtual environment constructing module 405, a virtual scene integrating module 406 and a virtual scene output module 407 which are connected sequentially. The data receiving module 401 may be further configured to connect to the mixed reality overlap module 404, and the mixed reality overlap module 404 may be also configured to connect to the virtual scene integrating module 406.

The data receiving module 401 may be configured to receive body movement data and body image data.

Specifically, the data receiving module 401 may receive the body movement data from an inertial sensor placed on main parts (such as a head, a hand, a foot, etc.) of the user's body and a plurality of optical devices (such as an infrared camera) placed in a space where the user is located and body image data transmitted by the plurality of cameras placed in the space in which the user is located, transmit the received body movement data to the movement analyzing module 402, and transmit the body image data to the mixed reality overlap module 404. The data receiving module 401 can receive data through a wired manner, and can also receive data through a wireless manner, or receive data through a combination of wired and wireless means, which is not specifically limited herein.

The movement analyzing module 402 may be configured to analyze the body movement data and establish a real-time exercise model.

Specifically, the movement analyzing module 402 may receive the body movement data transmitted by the data receiving module 401, analyze the received body movement data according to inertial navigation principles and computer vision principles, and estimate the body movement data at the next moment, so as to establish a real-time exercise model.

The virtual character generation module 403 may be configured to integrate a real-time exercise model and a virtual character image and generate a three-dimensional exercise virtual character.

The virtual character generation module 403 may further include following units.

A first detecting unit 4031 may be included and configured to detect whether there is a virtual character image setup command inputted.

Herein, the virtual character image setup command may include gender, height, weight, nationality, skin color, and the like, and the setup command may selected and inputted by means of voices, gestures, or buttons, and the like.

A virtual character generation unit 4032 may be included and configured to generate a virtual character image according to the virtual character image setup command when the virtual character image setup command inputted is detected, and integrate the real-time exercise model and the virtual character image to generate a three-dimensional exercise virtual character.

Specifically, the virtual character image can be generated according to the virtual character image setup command or may be a virtual character image generated according to default setting. The virtual character generation module 403 may integrate virtual character image with the real-time exercise model established by the movement analyzing module 402, and correct and process the real-time exercise model according to the body movement data, so as to generate a three-dimensional exercise virtual character and reflect the movement of the user of real space in real time.

A mixed reality overlap module 404 may be included and configured to integrate the three-dimensional exercise virtual character and the body image data, and generate mixed reality exercise image data.

Specifically, the mixed reality overlap module 404 may use the green screen or blue screen technology to select the user image in the body image data at different angles at the same time to process, so as to form a three-dimensional user image, and then integrate the three-dimensional user image and the three-dimensional exercise virtual character, that is, adjust the three-dimensional exercise virtual character, so as to integrate the three-dimensional exercise virtual character with the real-time three-dimensional user image, further to generate the mixed reality exercise image data.

A virtual environment constructing module 405 may be included and configured to construct a virtual exercise environment, wherein the virtual exercise environment includes at least a virtual background environment.

Herein, the virtual environment constructing module 405 further includes following units.

A second detecting unit 4051 (i.e., a virtual environment detecting unit) may be included and configured to detect whether there is at least one of a virtual background environment setup command and a virtual exercise mode setup command inputted.

Specifically, the second detecting unit 4051 may detect whether there is at least one of a virtual background environment setup command and a virtual exercise mode setup command inputted in the form of voices, gestures, buttons, and the like. The virtual background environment may be various backgrounds such as forests, grasslands, glaciers, or stages. The virtual exercise mode may be various modes such as dancing, running, or basketball, and will not be specifically limited herein.

A constructing unit 4052 may be included and configured to construct a virtual exercise environment according to the at least one of the virtual background environment setup command and the virtual exercise mode setup command when the at least one of the virtual background environment setup command and the virtual exercise mode setup command inputted is detected.

Specifically, when the second detecting unit 4051 detects that there is at least one of a virtual background environment setup command and a virtual exercise mode setup command inputted, the constructing unit 4052 can download the virtual background environment and/or virtual exercise mode data (such as dance audio, etc.) selected by the user through a local database or network, switch the virtual exercise background to the virtual exercise background selected by the user, and play the related audio, to generate a virtual exercise environment. If the second detecting unit 4051 does not detect at least one of the virtual background environment setup command and the virtual exercise mode setup command inputted, the virtual exercise environment may be generated with a least one of a default virtual background environment and a default virtual exercise mode (such as a stage and/or dancing).

A virtual scene integrating module 406 may be included and configured to integrate mixed reality exercise image data and the virtual exercise environment to generate a virtual exercise scene.

Specifically, the virtual scene integrating module 406 may perform edge processing on the mixed reality exercise image data generated by the mixed reality overlap module 404 to merge with the virtual exercise environment generated by the virtual environment constructing module 405, to finally generate a virtual exercise scene.

A virtual scene output module 407 may be included and configured to output a virtual exercise scene.

Specifically, the virtual scene output module 407 may output the video data of the virtual exercise scene to the display screen for displaying, and output the audio data of the virtual exercise scene to a speaker or a headphone or the like for playing, and output the tactile data of the virtual exercise scene to a tactile sensor for tactile feedback.

In the above embodiment, the smart head-mounted device integrates the virtual exercise character and the body image data to generate mixed reality exercise image data, so that the exercise image of the real character can be reflected to the virtual exercise character in real time, and the exactness of the real character can be improved. By constructing the virtual exercise environment, a pleasant exercise environment can be created, providing a more true immersion sense.

In other embodiments, the smart head-mounted device can also be added with a sharing function, to share the virtual exercise scene with friends, thus increasing interaction, and improving the exercise fun.

Specifically referring to FIG. 5, FIG. 5 is a schematic structural diagram of a second embodiment of a smart head-mounted device according to the present disclosure. As is similar to the structure of FIG. 4, FIG. 5 is not described here again. The difference is that the smart head-mounted device 50 of the present disclosure further includes a sharing module 508, and the sharing module 508 is connected to the virtual scene output module 507.

Herein, the sharing module 508 may include a third detecting unit 5081 (i.e., a sharing detecting unit) and a sharing unit 5082.

The third detecting unit 5081 may be configured to detect whether there is a sharing command inputted.

The sharing unit 5082 may be configured to transmit the virtual exercise scene to a friend or a social platform corresponding to the sharing command to realize sharing, when a sharing command inputted is detected.

The sharing command may be inputted through voices, gestures, or buttons, the sharing command may include a shared content and a shared object, and the shared content may include a current virtual exercise scene and a saved historical virtual exercise scene (video and/or image). The shared objects may include friends and each social platform.

Specifically, when the third detecting unit 5081 detects that there is a sharing command inputted, the sharing unit 5082 may transmit the corresponding shared content to the corresponding social platform corresponding to the shared content, if the shared object of the sharing command is a social platform. If the shared object of the command is a friend, the pre-saved friends list can be browsed. If the shared object is found, the sharing unit 5082 may transmit the corresponding shared content to the shared object. If the shared object is not found in the saved friends list, then a virtual exercise scene will not be transmitted to the shared object while a prompt message is outputted instead.

For example, the user inputs the following sharing command “share video B to friend A and moments of WeChat” by pressing a button, the third detecting unit 5081 can detect the above sharing command inputted, and the sharing unit 5082 can share the video B to the moments of WeChat, and search the pre-saved friends list for friend A, and transmit the video B to the friend A when friend A is found.

In other embodiments, the smart head-mounted device can also be added with virtual coach guiding functions, to increase human-computer interaction and enhance the scientificness and interests.

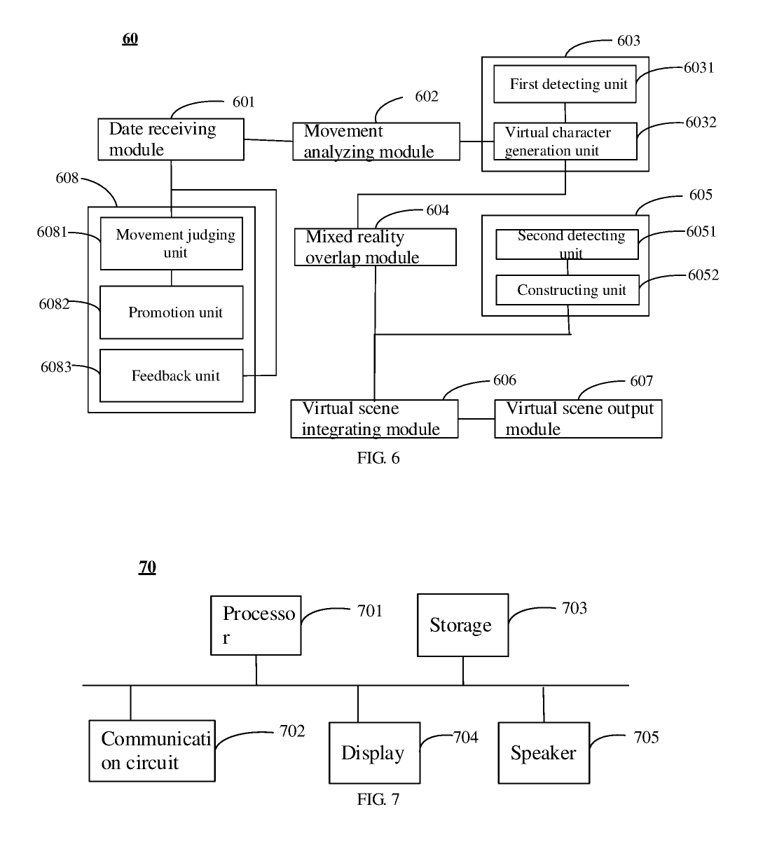

Referring specifically to FIG. 6, FIG. 6 is a schematic structural diagram of a third embodiment of a smart head-mounted device according to the present disclosure. As is similar to the structure of FIG. 4, FIG. 6 is not described here again. The difference is that the smart head-mounted device 60 of the present disclosure may further include a virtual coach guiding module 608, and the virtual coach guiding module 608 may be connected to the data receiving module 601.

Herein, the virtual coach guiding module 608 may include: a movement judging unit 6081, a promotion unit 6082, and a feedback unit 6083. The promotion unit 6082 may be connected to the movement judging unit 6081, and the movement judging unit 6081 and the feedback unit 6083 may be respectively connected to the data receiving module 601.

The movement judging unit 6081 may be configured to compare and analyze the body movement data and the standard movement data to judge whether the body movement data is standard.

The standard movement data may be data pre-saved in the database or expert system or downloaded through the network, including the trajectory, angle, strength of the movement, and the like.

Specifically, when the movement judging unit 6081 compares and analyzes the body movement data received by the data receiving module 601 and the standard movement data, a corresponding threshold may be configured, and when the difference between the body movement data and the standard movement data exceeds the preset threshold, it can be judged that the body movement data is not standard, otherwise the body movement data can be judged to be standard. It is certain that, during comparing and analyzing process, other methods can be used to judge whether the body movement data is standard, which will not be specifically limited herein.

The promotion unit 6082 may be configured to transmit a correction message for a reminder when the body movement data is not standard.

Specifically, when the body movement data is not standard, the promotion unit 6082 may transmit the correction message for a reminder a combination of one or more means of voices, videos, images or texts.

The feedback unit 6083 may be configured to calculate exercise intensity according to the body movement data, and transmit the feedback and suggestion message according to the exercise intensity.

Specifically, the feedback unit 6083 may calculate the exercise intensity according to the received body movement data in combination with the exercise duration, and transmits messages suggesting to increase the exercise time or reduce the exercise intensity during the exercise, or transmit messages of such as refueling with hydration or food recommendations after the exercise ends, so that users can know their own exercise state and can exercise more scientifically and healthily.

Referring to FIG. 7, FIG. 7 is a smart head-mounted device of the fourth embodiment of the present disclosure.

Herein, a communication circuit 702 may be included and configured to receive body movement data and body image data.

A storage 703 may be included and configured to store data required by the processor 701.

A processor 701 may be included and configured to analyze the body movement data received by the communication circuit 702, establish a real-time exercise model, integrate the real-time exercise model and the virtual character image to generate a three-dimensional exercise virtual character, and then integrate the three-dimensional exercise virtual character and the body image data to generate mixed reality exercise image data to construct a virtual exercise environment, then integrate the mixed reality exercise image data and the virtual exercise environment to generate a virtual exercise scene, and finally output the generated virtual exercise scene. The processor 701 may output video data of the virtual exercise scene to the display 704 for displaying, and outputs the audio data of the virtual exercise scene to the speaker 705 for playing.

Herein, the virtual exercise environment may include at least a virtual background environment, and a pleasant exercise environment can be created according to a command inputted by the user.

The processor 701 may be further configured to detect whether there is a sharing command inputted, and when it is detected that there is a sharing command inputted, a virtual exercise scene can be transmitted to the friend or the social platform corresponding to the sharing command through the communication circuit 702 to realize sharing.

In addition, the processor 701 may be further configured to compare and analyze the body movement data and the standard movement data, judge whether the body movement data is standard, and transmit a correction message for a reminder through the display 704 and/or the speaker 705 when the body movement data is not standard, calculate the exercise intensity according to the body movement data, and transmit a feedback and suggestion message through the display 704 and/or the speaker 705.

In the above embodiment, the smart head-mounted device may integrate the virtual exercise character and the body image data to generate mixed reality exercise image data, so that the exercise image of the real character can be reflected to the virtual exercise character in real time, and the exactness of the real character can be improved. By constructing the virtual exercise environment, a pleasant exercise environment can be created, providing a more true immersion sense. With the added sharing functions, the virtual exercise scene may be shared with friends, thus increasing interaction, and improving the exercise fun. For the added virtual coach guiding function, human-computer interaction may be increased, enhancing the scientificness and interests.

The above description merely illustrates some exemplary embodiments of the disclosure, which however are not intended to limit the scope of the disclosure to these specific embodiments. Any equivalent structural or flow modifications or transformations made to the disclosure, or any direct or indirect applications of the disclosure on any other related fields, shall all fall in the scope of the disclosure.

What is claimed is:

1. An interactive exercise method, comprising:
receiving body movement data and body image data;
analyzing the body movement data to establish a real-time exercise model;
integrating the real-time exercise model and a virtual character image to generate a three-dimensional exercise virtual character;
integrating the three-dimensional exercise virtual character and the body image data to generate mixed reality exercise image data;
constructing a virtual exercise environment, wherein the virtual exercise environment comprises at least a virtual background environment;
integrating the mixed reality exercise image data and the virtual exercise environment to generate a virtual exercise scene; and
outputting the virtual exercise scene.

2. The interactive exercise method according to claim 1, wherein after the outputting the virtual exercise scene, the method further comprises:
detecting whether there is a sharing command inputted; and
transmitting the virtual exercise scene to a friend or a social platform corresponding to the sharing command to realize sharing, if the sharing command inputted is detected.

3. The interactive exercise method according to claim 1, wherein the constructing the virtual exercise environment specifically comprises:
detecting whether there is at least one of a virtual background environment setup command and a virtual exercise mode setup command inputted; and
constructing the virtual exercise environment according to the at least one of the virtual background environment setup command and the virtual exercise mode setup command, if the at least one of the virtual background environment setup command and the virtual exercise mode setup command inputted is detected.

4. The interactive exercise method according to claim 1, wherein after outputting the virtual exercise scene, the method further comprises:
comparing and analyzing the body movement data and standard movement data to judge whether the body movement data is standard;
transmitting a correction message for a reminder, if the body movement data is not standard; and
calculating an exercise intensity according to the body movement data, and transmitting a feedback and suggestion message according to the exercise intensity.

5. The interactive exercise method according to claim 1, wherein before integrating the real-time exercise model and the virtual character image, the method further comprises:
detecting whether there is a virtual character image setup command inputted; and
generating the virtual character image according to the virtual character image setup command, if the virtual character image setup command inputted is detected.

6. A smart head-mounted device, comprising: a processor and a communication circuit connected to the processor, wherein
the communication circuit is configured to receive body movement data and body image data;
the processor is configured to analyze the body movement data to establish a real-time exercise model, integrate the real-time exercise model and the virtual character image to generate a three-dimensional exercise virtual character, and then integrate the three-dimensional exercise virtual character and the body image data to generate mixed reality exercise image data, construct a virtual exercise environment, integrate the mixed reality exercise image data and the virtual exercise environment to generate a virtual exercise scene, and output the virtual exercise scene, the virtual exercise environment at least comprising a virtual background environment.

7. The smart head-mounted device according to claim 6, wherein after outputting the virtual exercise scene, the processor is further configured to:
detect whether there is a sharing command inputted; and
transmit the virtual exercise scene to a friend or a social platform corresponding to the sharing command to realize sharing, if the sharing command inputted is detected.

8. The smart head-mounted device according to claim 6, wherein the processor is configured to construct the virtual exercise environment specifically comprises:
the processor is configured to detect whether there is at least one of a virtual background environment setup command and a virtual exercise mode setup command inputted; and
the processor is configured to construct the virtual exercise environment according to the at least one of the virtual background environment setup command and the virtual exercise mode setup command, if the at least one of the virtual background environment setup command and the virtual exercise mode setup command inputted is detected.

9. The smart head-mounted device according to claim 6, wherein after the processor is configured to output the virtual exercise scene, the processor is further configured to:
compare and analyze the body movement data and standard movement data to judge whether the body movement data is standard;
transmit a correction message for a reminder, if the body movement data is not standard; and
calculate an exercise intensity according to the body movement data, and transmit a feedback and suggestion message according to the exercise intensity.

10. The smart head-mounted device according to claim 6, wherein before integrating the real-time exercise model and the virtual character image, the processor is further configured to:
detect whether there is a virtual character image setup command inputted; and
generate the virtual character image according to the virtual character image setup command, if the virtual character image setup command inputted is detected.

11. An interactive exercise system comprising:
a plurality of inertial sensors configured to be placed in main parts of user's body;
a plurality of optical devices configured to be placed in a space where the user is located, corporate with the inertial sensors to obtain body movement data;
a plurality of cameras configured to be placed in the space and obtain body image data; and
a smart head-mounted device configured to receive the body movement data and the body image data, analyze the body movement data to establish a real-time exercise model, integrate the real-time exercise model and the virtual character image to generate a three-dimensional exercise virtual character, and then integrate the three-dimensional exercise virtual character and the body image data to generate mixed reality exercise image data, construct a virtual exercise environment, integrate the mixed reality exercise image data and the virtual exercise environment to generate a virtual exercise scene, and output the virtual exercise scene, the virtual exercise environment at least comprising a virtual background environment.

12. The interactive exercise system according to claim 11, wherein after outputting the virtual exercise scene, the smart head-mounted device is further configured to:
detect whether there is a sharing command inputted; and
transmit the virtual exercise scene to a friend or a social platform corresponding to the sharing command to realize sharing, if the sharing command inputted is detected.

13. The interactive exercise system according to claim 11, wherein the smart head-mounted device is further configured to:
detect whether there is at least one of a virtual background environment setup command and a virtual exercise mode setup command inputted; and
construct the virtual exercise environment according to the at least one of the virtual background environment setup command and the virtual exercise mode setup command, if the at least one of the virtual background environment setup command and the virtual exercise mode setup command inputted is detected.

14. The interactive exercise system according to claim 11, wherein after the smart head-mounted device is configured to output the virtual exercise scene, the smart head-mounted device is further configured to:
compare and analyze the body movement data and standard movement data to judge whether the body movement data is standard;
transmit a correction message for a reminder, if the body movement data is not standard; and
calculate an exercise intensity according to the body movement data, and transmit a feedback and suggestion message according to the exercise intensity.

15. The interactive exercise system according to claim 11, wherein before integrating the real-time exercise model and the virtual character image, the smart head-mounted device is further configured to:
detect whether there is a virtual character image setup command inputted; and
generate the virtual character image according to the virtual character image setup command, if the virtual character image setup command inputted is detected.
